(19) United States
(12) Patent Application Publication
(10) Pub. No.: US 2009/0014434 A1
(43) Pub. Date: Jan. 15, 2009

(54) PRESSURE AND TEMPERATURE BALANCING VALVE SYSTEM FOR A ROMAN RUB

(76) Inventor: Cary E. Gloodt, Burr Ridge, IL (US)

Correspondence Address: Brannon & Associates PC, 1 North Pennsylvania Street, Suite 520, Indianapolis, IN, 46204, US

(21) Appl. No.: 12/172,747

(22) Filed: Jul. 14, 2008

Related U.S. Application Data
(63) Continuation of application No. 10/796,325, filed on Mar. 9, 2004, now abandoned.

(51) Int. Cl. H05B 1/02

(52) U.S. Cl. 219/494

(57) ABSTRACT

A freestanding or Roman bathtub plumbing system including a bathtub filler (such as a spout and/or hand-held shower) controlled by a compact thermostatic mixing valve. The thermostatic mixing valve is installed in a bathtub plumbing set having a hand-held shower accessory. The thermostatic mixing valve receives hot and cold water from the main hot and cold water inlet pipes, respectively, located upstream of the respective hot and cold water control valves used to control the supply of water to the fillers. The hot and cold water feed pipes are each hydraulically connected to a first respective hot and cold water inlet of the thermostatic mixing valve. The bathtub fillers are hydraulically connected to the outlet of the thermostatic mixing valve, such as by a pipe or flexible hose. Hot and cold water entering the thermostatic mixing valve are mixed therein independently; water exiting the thermostatic mixing valve is characterized by a predetermined maximum temperature, such that a tub occupant will not be accidentally scalded.

### CROSS-REFERENCE TO RELATED APPLICATIONS

This application is a Continuation of currently pending U.S. patent application Ser. No. 10/796,325, which claims priority to U.S. Provisional Application Ser. No. 60/240,609 filed Oct. 16, 2000; U.S. patent application Ser. No. 09/960,440, filed Sep. 21, 2001 and issued on Nov. 11, 2003 as U.S. Pat. No. 6,644,333; and U.S. patent application Ser. No. 10/704,086, filed Nov. 7, 2003.

### TECHNICAL FIELD OF THE INVENTION

The present invention relates generally to bathtub plumbing systems and, more particularly, to a plumbing system mounted under the deck of a freestanding or Roman bathtub including an anti-scald feature fluidically connected to the tub-filling water outlet(s) and controlled by a pressure and/or volume and/or temperature controlled mixing valve.

### BACKGROUND OF THE INVENTION

Freestanding or Roman bathtubs have been in use since the dawn of plumbing, and the piping and fixtures connected to Roman tubs have remained essentially unchanged throughout that time. Roman bathtubs have long been filled by a central fill spout fed by hot and cold water sources, each respectively controlled by a hot and cold inlet valve. Thus, when the hot valve is opened with the cold valve shut, water at the hot water supply temperature flows through the spout and into the tub. This has not been considered especially hazardous, as Roman tubs are typically filled without an occupant present and do not include a shower attachment.

However, Roman bathtubs are being increasingly fitted with hand held shower sprayers, that are attached to the water supplies via secondary piping extending between the main inlets and a diverter, to which a hose is attached to deliver water to the sprayer. Thus, water at the hot water source temperature may be sprayed onto an unwary bather. The problem is even more acute if the bather is an infant being washed by an adult; if the adult forgets to test the water from the sprayer, the infant may be scalded. Further, even if the water temperature is properly balanced through a mixture of hot and cold water, a sudden drain on the cold water supply (such as through flushing a toilet or the like) may suddenly allow the water temperature at the sprayer to increase sufficiently to scald. Moreover, there is always the likelihood of a bather in the bathtub inadvertently opening the hot water valve and receiving a scalding blast of water through the spout and/or the sprayer.

FIG. 1 illustrates a typical prior art Roman tub plumbing system. A hand-held shower 10 is plumbed by combining the hot water inlet and the cold water inlet lines 12, 14 from the separate hot and cold control valves 16, 18 at a diverter valve 20. A flexible hose 22 fluidically connects the hand-held shower 10 to the diverter valve 20. The diverter valve 20 combines hot and cold water arriving through the respective hot and cold inlet lines 12, 14, but does not act to balance the temperature or pressure of the water. Temperature and pressure adjustments are made by opening the hot and cold control valves 16, 18 in conjunction.

The above system has the disadvantage of requiring simultaneous control of both the hot and the cold control valves 16, 18 to achieve a desired pressure and temperature combination. While it is not difficult to achieve either a desired water temperature or a desired water pressure in this way, achieving both at once is trickier. In addition to the inherent difficulties of achieving a water flow having both the desired temperature and pressure, the situation is further complicated because the system ideally requires one hand to adjust the hot water valve 16, a second hand to adjust the cold water valve 18, and a third hand to manipulate the hand-held shower 10. While the hot and cold water valves 16, 18 may be adjusted prior to opening the diverter valve 20, the effective water pressure exiting the hand-held shower 10 is usually different from that exiting the tub faucet 24, since the faucet 24 and the hand-held shower 10 typically have different dimensions. Therefore, fine-tuning adjustments are required to arrive at the desired water temperature-pressure combination. Alternatively, the hot and cold water valves 16, 18 may be adjusted while the diverter valve 20 is open and water is flowing from the hand-held shower 10, but this necessitates simultaneous control of both valves 16, 18 and the hand-held shower 10, posing a difficulty for a single individual having only two hands.

While thermostatic and/or pressure balancing valves are well known in the art, they have typically been too large, bulky and expensive to be readily accommodated into a hand-held shower system. There is therefore a need for a way of easily controlling the water temperature and pressure of a Roman bathtub, especially one including a hand-held shower system. The present invention is directed towards meeting this need.

### SUMMARY OF THE INVENTION

The present invention relates to a Roman bathtub fill plumbing system (preferably including a hand-held shower feature) controlled by an anti-scald valve (such as a thermostatic mixing valve). In one preferred embodiment, a compact thermostatic tempering valve is installed in the hot water supply line in a Roman bathtub plumbing set. The thermostatic valve limits the maximum temperature of hot water entering the tub through a fill mechanism, such as a spout or sprayer.

One object of the present invention is to provide an improved Roman bathtub fill system. Related objects and advantages of the present invention will be apparent from the following description.

### BRIEF DESCRIPTION OF THE DRAWINGS

FIG. 1 is a schematic view of a prior art hand-held shower system including a diverter valve.

FIG. 2 is a schematic view of a first embodiment of the Roman bathtub plumbing system of the present invention.

FIG. 3 is a schematic view of a second embodiment of the Roman bathtub plumbing system of the present invention.

FIG. 4 is a schematic view of a third embodiment Roman bathtub plumbing system of the present invention.

FIG. 5 is a schematic view of a fourth embodiment Roman bathtub plumbing system of the present invention.

FIG. 6 is a schematic view of a fifth embodiment Roman bathtub plumbing system of the present invention.

FIG. 7 is a schematic view of a sixth embodiment Roman bathtub plumbing system of the present invention.

FIG. 8 is a schematic view of a seventh embodiment Roman bathtub plumbing system of the present invention.

FIG. 9 is a schematic view of an eighth embodiment Roman bathtub plumbing system of the present invention.

FIG. 10 is a schematic view of a ninth embodiment Roman bathtub plumbing system of the present invention.

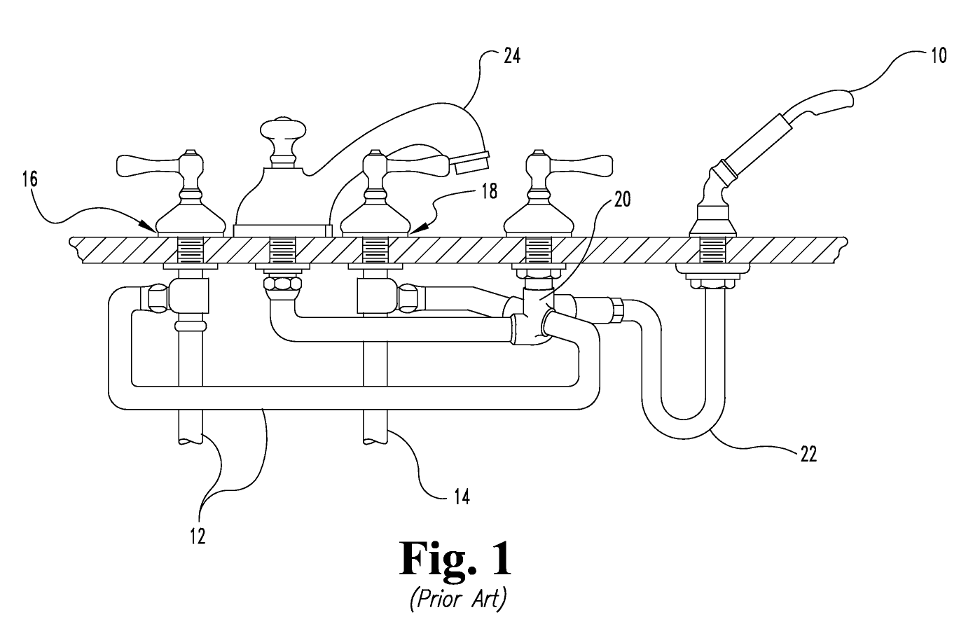

### DETAILED DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

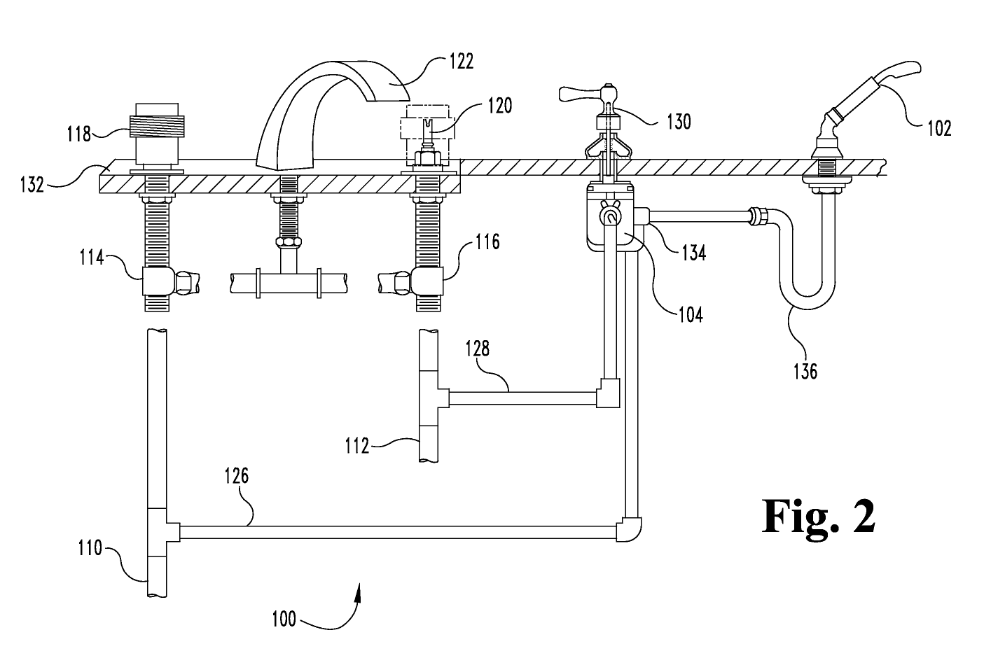

FIG. 2 schematically illustrates a first embodiment of the present invention, a bathtub plumbing system 100 including a hand-held shower 102 controlled by an anti-scald valve 104, such as, for example and not by limitation, a Grohe temp valve, model number 34-910-000. The system 100 also includes a main hot water pipe 110 and a main cold water pipe 112 for supplying hot and cold water, respectively. The main hot water pipe 110 is connected to a hot water control valve 114 and the main cold water pipe is connected to a cold water control valve 116. The hot and cold water control valves 114, 116 are respectively operated by a hot and cold water control valve handles 118, 120. The hot and cold water control valves 114, 116 are fluidically connected to a faucet 122.

A hand-held shower hot water feed pipe 126 is fluidically connected to the main hot water pipe 110 upstream of the hot water control valve 114. A hand-held shower cold water feed pipe 128 is likewise fluidically connected to the main cold water pipe 112 upstream of the cold water control valve 116. The hand-held shower hot and cold water feed pipes 126, 128 are fluidically connected to a compact anti-scald valve 104 spaced from the hot and cold water valves 114, 116. The compact anti-scald valve 104 also preferably includes a mixed water control valve handle 130 extending therefrom. Preferably, the valves 114, 116, 104 are located beneath the tub surface 132 while the handles 118, 120, 130 extend through the tub surface 132. More preferably, the dimensions of the fixtures located below the surface are such that the handles 118, 120, 130 may be arranged in an ergonomic and decorative design.

The anti-scald valve 104 also includes an outlet 134 to which the hand-held shower 102 be fluidically connected. Preferably, a length of flexible hose 136 fluidically connects the anti-scald valve 104 to the hand held shower 102.

In operation, the anti-scald valve 104 serves to mix the hot and cold water flowing thereinto independently of the water supplying the faucet 122. The anti-scald valve 104 allows single-handle control of the temperature and pressure of the water supplied the to hand-held shower 102. The use of a compact anti-scald valve 104 in the system 100 eliminates the necessity for a diverter valve, thereby reducing the number and complexity of the required plumbing fittings as well as reducing the cost of the system 100.

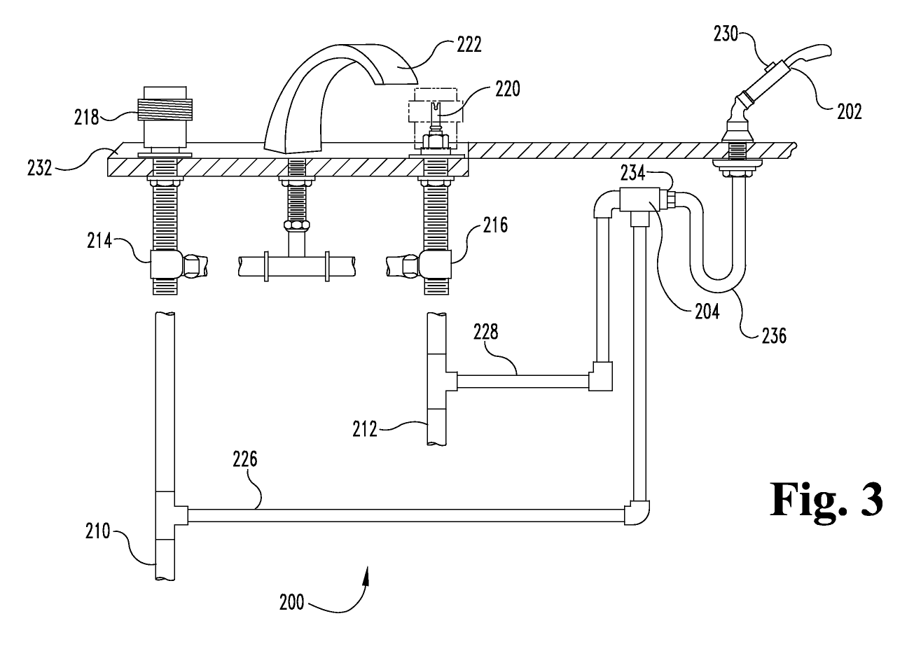

FIG. 3 schematically illustrates a second embodiment of the present invention, a bathtub plumbing system 200 including a hand-held shower 202 controlled by an anti-scald valve 204, such as, for example and not by limitation, a Lawler TMM-1000 thermostatic mixing valve. The system 200 also includes a main hot water pipe 210 and a main cold water pipe 212 for supplying hot and cold water, respectively. The main hot water pipe 210 is connected to a hot water control valve 214 and the main cold water pipe is connected to a cold water control valve 216. The hot and cold water control valves 214, 216 are respectively operated by a hot and cold water control valve handles 218, 220. The hot and cold water control valves 214, 216 are fluidically connected to a faucet 222.

A hand-held shower hot water feed pipe 226 is fluidically connected to the main hot water pipe 210 upstream of the hot water control valve 214. A hand-held shower cold water feed pipe 228 is likewise fluidically connected to the main cold water pipe 212 upstream of the cold water control valve 216. The hand-held shower hot and cold water feed pipes 226, 228 are fluidically connected to a compact anti-scald valve 204 spaced from the hot and cold water valves 214, 216. The hand-held shower 202 preferably includes a simple flow control valve member 230 for actuating and, more preferably, controlling the flow of water therethrough. Preferably, the valves 214, 216, 204 are located beneath the tub surface 232 while the handles 218, 220 extend through the tub surface 232. More preferably, the dimensions of the fixtures located below the surface are such that the handles 218, 220, may be arranged in an ergonomic and decorative design.

The anti-scald valve 204 also includes an outlet 234 to which the hand-held shower 202 be fluidically connected. Preferably, a length of flexible hose 236 is fluidically connected between the anti-scald valve 204 and the hand held shower 202. Also preferably, the hand-held shower head 202 includes an actuation valve, such that the flow of water may be enabled or disabled at the shower head 202.

In operation, the anti-scald valve 204 serves to mix the hot and cold water flowing thereinto independently of the water supplying the faucet or spout 222. The anti-scald valve 204 provides water at a predetermined maximum temperature to hand-held shower 202. Preferably, the anti-scald valve also controls the water pressure to the hand-held shower 202 by reducing pressure fluctuations and providing a predetermined maximum pressure limit. More preferably, the anti-scald valve 204 both balances the temperature of the mixed water and reduces pressure fluctuations at the hand-held shower 202. Still more preferably, the anti-scald valve 204 balances both the temperature and the pressure of the mixed water flowing therefrom. The use of a compact anti-scald valve 204 in the system 200 eliminates the necessity for a diverter valve, thereby reducing the number and complexity of the required plumbing fittings as well as reducing the cost of the system 200.

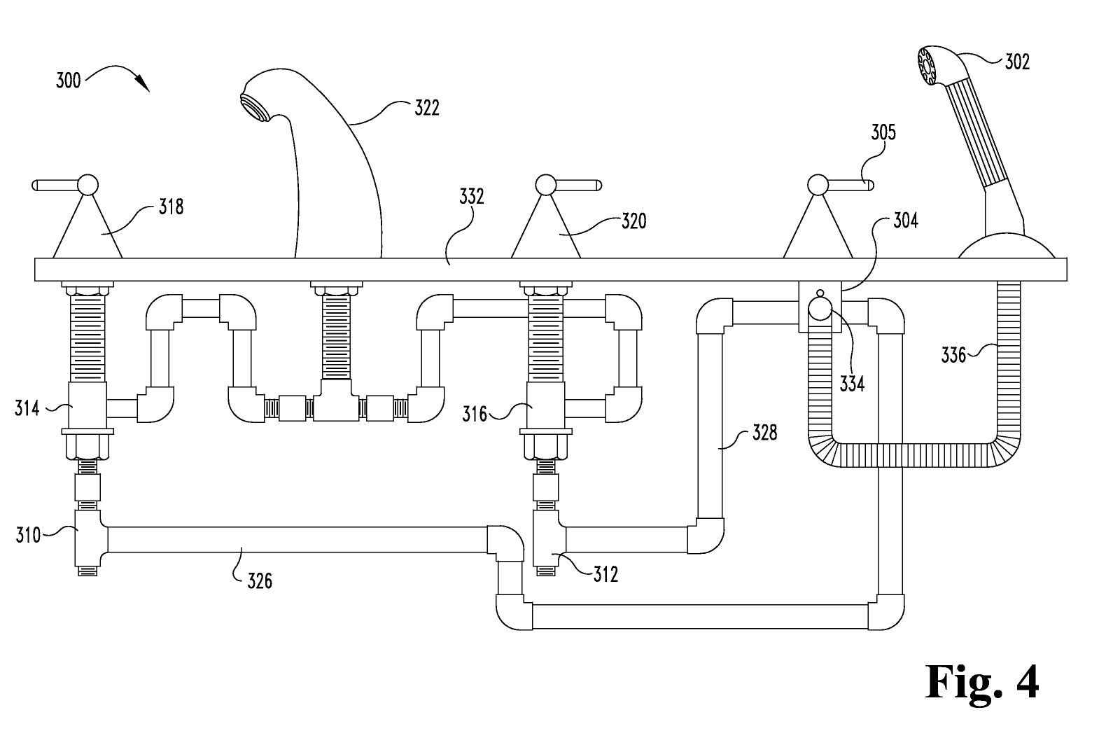

FIG. 4 schematically illustrates a third embodiment of the present invention, a bathtub plumbing system 300 including a hand-held shower sprayer 302 fluidically connected to a pressure-balancing valve 304. Valve handle 305 is operationally connected to valve 304. The system 300 also includes a main hot water pipe 310 and a main cold water pipe 312 hydraulically connected for supplying hot and cold water, respectively. The main hot water pipe 310 is connected to a hot water control valve 314 and the main cold water pipe is connected to a cold water control valve 316. The hot and cold water control valves 314, 316 are respectively operated by a hot and cold water control valve handles 318, 320. The hot and cold water control valves 314, 216 are fluidically connected to a faucet or fill spout 322 for filling a bathtub with water.

A hand-held shower hot water feed pipe 326 is fluidically connected to the main hot water pipe 310 upstream of the hot water control valve 314. A hand-held shower cold water feed pipe 328 is likewise fluidically connected to the main cold water pipe 312 upstream of the cold water control valve 316. The hand-held shower hot and cold water feed pipes 326, 328 are fluidically connected to the pressure balancing valve 304 spaced from the hot and cold water valves 314, 316. Fluid flow through the hand-held shower 302 is thus controlled by valve 304. Preferably, valves 314, 316, and 304 are located beneath the tub surface 332 while the handles 318, 320 and 305 extend through the tub surface 332. More preferably, the dimensions of the fixtures located below the surface are such that the handles 318, 320 and 305 may be arranged in an ergonomic and decorative design.

The pressure balancing valve 304 also includes an outlet 334 to which the hand-held shower 302 be fluidically connected. Preferably, a length of flexible hose 336 is fluidically connected between the valve 304 and the hand held shower 302.

In operation, the valve 304 serves to mix the hot and cold water flowing thereinto independently of the water supplying the faucet 322. Valve 304 provides water at a predetermined maximum pressure to hand-held shower 302. Preferably, valve 304 controls the water pressure to the hand-held shower 302 by reducing pressure fluctuations as well as providing a predetermined maximum pressure limit. More preferably, valve 304 is also a temperature balancing valve 304 that both balances the temperature of the mixed water and reduces pressure fluctuations at the hand-held shower 302. Still more preferably, the anti-scald valve 304 balances both the temperature and the pressure of the mixed water flowing therefrom. The use of a compact anti-scald valve 304 in the system 300 eliminates the necessity for a diverter valve, thereby reducing the number and complexity of the required plumbing fittings as well as reducing the cost of the system 300.

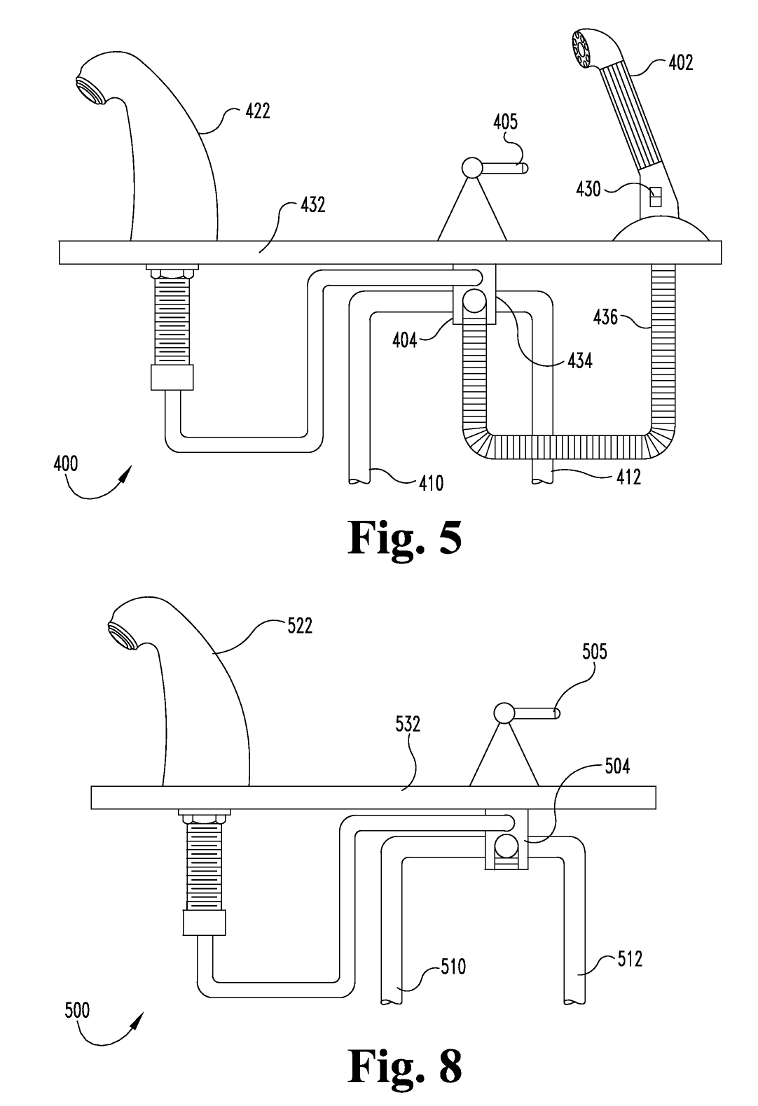

FIG. 5 schematically illustrates a fourth embodiment of the present invention, a bathtub plumbing system 400 including a hand-held shower 402 controlled by an anti-scald valve 404, such as a thermostatic mixing valve. The system 400 also includes a main hot water pipe 410 and a main cold water pipe 412 for supplying hot and cold water, respectively. The main hot water pipe 410 and the main cold water pipe 412 are connected to the respective appropriate inlets of the thermostatic mixing valve 404. The valve 404 is operated by a control valve handle 405. The valve 404 is fluidically connected to both a bathtub fill spout or faucet 422 and to a hand-held shower sprayer 402.

The hand-held shower 402 preferably includes a simple flow control valve member 430 for actuating and, more preferably, controlling the flow of water therethrough. Preferably, the valve 404 is positioned beneath the tub surface 432 while the handle 405 extends through the tub surface 432.

The anti-scald valve 404 also includes an outlet 434 to which the hand-held shower 402 be fluidically connected. Preferably, a length of flexible hose 436 is fluidically connected between the anti-scald valve 404 and the hand held shower 402. Also preferably, the hand-held shower head 402 includes an actuation valve 430, such that the flow of water may be enabled or disabled at the shower head 402.

In operation, the anti-scald valve 404 serves to mix the hot and cold water flowing thereinto for supplying the tub fillers 403, 422, i.e., the faucet 422 and/or the hand-held sprayer 402. The anti-scald valve 404 provides water at a predetermined maximum temperature to hand-held shower 402. Preferably, the anti-scald valve also controls the water pressure to the hand-held shower 402 by reducing pressure fluctuations and providing a predetermined maximum pressure limit. More preferably, the anti-scald valve 404 both balances the temperature of the mixed water and reduces pressure fluctuations at the hand-held shower 402. Still more preferably, the anti-scald valve 404 balances both the temperature and the pressure of the mixed water flowing therefrom. The use of a compact anti-scald valve 404 in the system 400 eliminates the necessity for a diverter valve, thereby reducing the number and complexity of the required plumbing fittings as well as reducing the cost of the system 400.

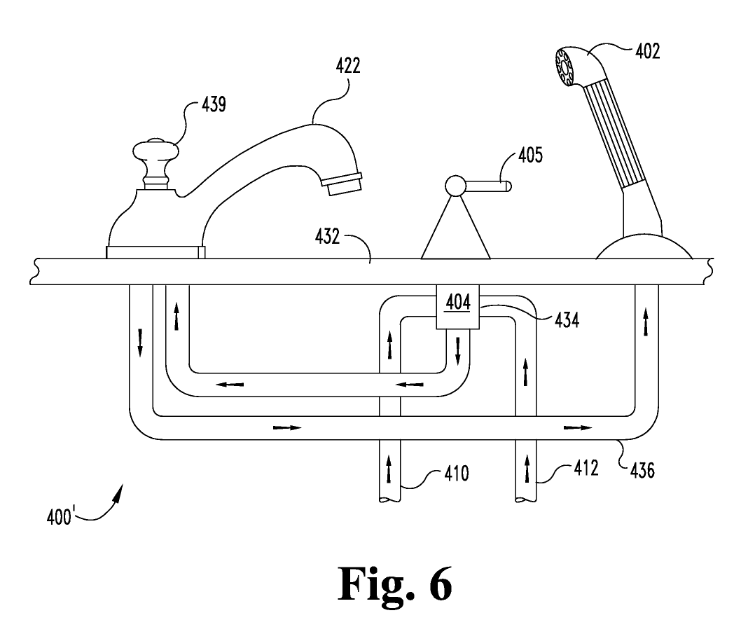

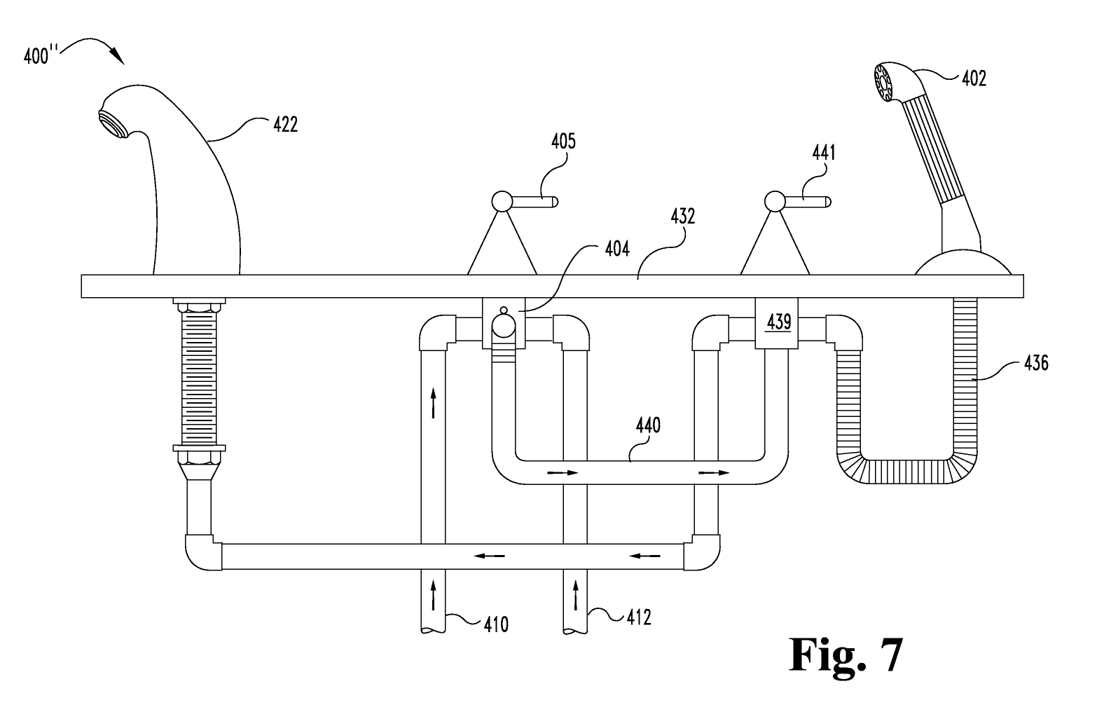

FIGS. 6 and 7 illustrate fifth and sixth embodiment systems 400′ and 400″, respectively, that are identical to the system described above regarding FIG. 5, with the exception of the addition of a diverter 439 fluidically connected to supply water to the hand-held sprayer 402. Referring to FIG. 6, the diverter 439 is of the stem-pull type and is incorporated into the spigot 422. The diverter may be actuated to send mixed water from the valve 404 through the spigot 422 into the bathtub, or instead through hose 436 (hydraulically or fluidically connected to diverter 439) to the hand-held sprayer 402. FIG. 7 illustrates a similar system, except that the diverter 439 is mounted to the tub deck 432 and is fluidically connected to valve 404 via pipe 440 for receiving mixed water therefrom. Diverter is also fluidically connected to spigot 422 and sprayer 402 for delivering mixed water thereto. The diverter 439 further includes a valve handle 441 connected thereto and extending through deck 432. Handle 441 may be operated to actuate diverter 439 to send water to spigot 422 or through hose 436 to hand-held sprayer 402.

FIG. 8 schematically illustrates a seventh embodiment of the present invention, a bathtub plumbing system 500 including an anti-scald valve 504, such as, for example and not by limitation, a Lawler TMM-1000 thermostatic mixing valve or the like having valve inputs fluidically connected to a main hot water pipe 510 and a main cold water pipe 512, respectively. The valve mixes the inflowing hot and cold water and outputs the mixed water to faucet or spout 522 fluidically connected thereto. Preferably, the valve 504 further includes a control handle 505 operationally connected thereto, but may alternately be of the in-line type. Preferably, the valve 504 is located beneath the tub deck surface 532 while the handle 505 extends through the tub deck surface 532.

In operation, the anti-scald valve 504 serves to mix the hot and cold water flowing thereinto for supplying to the faucet 522. The anti-scald valve 504 provides water at a predetermined maximum temperature to the spout 522. Preferably, the anti-scald valve 504 also controls the water pressure to spout 522 by reducing pressure fluctuations and providing a predetermined maximum pressure limit. More preferably, the anti-scald valve 504 both balances the temperature of the mixed water and reduces pressure fluctuations at the spout 522. Still more preferably, the anti-scald valve 504 balances both the temperature and the pressure of the mixed water flowing therefrom. The use of a compact anti-scald valve 504 in the tub fill system 500 eliminates the likelihood of accidentally scalding an occupant of the tub, such as a child or infant, while the tub is being filled or if the spout 522 is accidentally actuated.

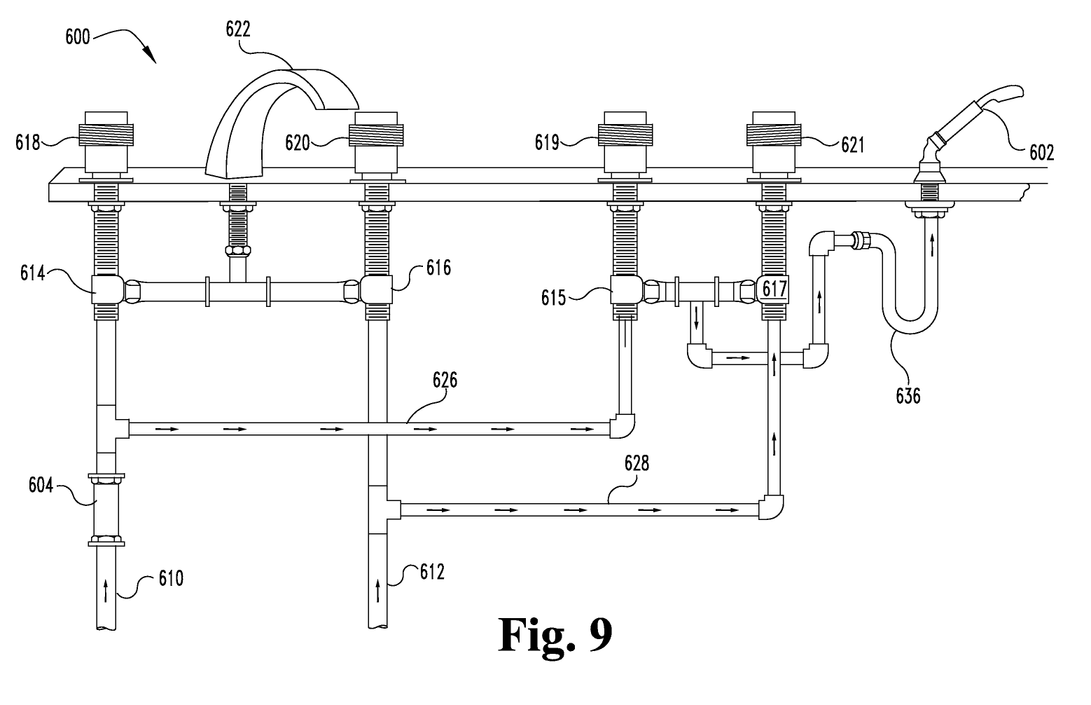

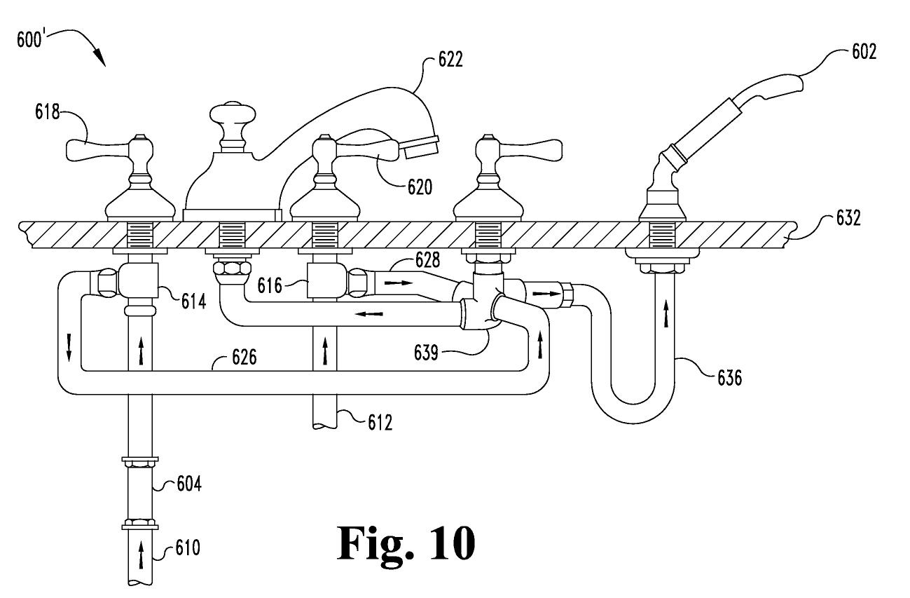

FIGS. 9 and 10 schematically illustrate an eighth and ninth embodiment of the present invention. The embodiment of FIG. 9 illustrates a bathtub plumbing system 600 including a hand-held shower 602 controlled by an in-line thermally tempering anti-scald valve 604, such as, for example and not by limitation, a Lawler TMM-1000 thermostatic mixing valve. The system 600 also includes a main hot water pipe 610 and a main cold water pipe 612 for supplying hot and cold water, respectively. The main hot water pipe 610 and the main cold water pipe 612 are connected to the respective appropriate inlets of the thermostatic mixing valve 604. The valve 604 is fluidically connected to both a bathtub fill spout or faucet 622 and to a hand-held shower sprayer 602. The main hot water pipe 610 is connected to a spout hot water control valve 614 and via a secondary hot water pipe 626 to a sprayer hot water control valve 615; the main cold water pipe is connected to a spout cold water control valve 616 and via a secondary cold water pipe 628 to a sprayer cold water control valve 617. The spout hot and cold water control valves 614 and 616 are respectively operated by a spout hot and cold water control valve handles 618 and 620. The sprayer hot and cold water control valves 615 and 617 are respectively operated by a sprayer hot and cold water control valve handles 619 and 621. The spout hot and cold water control valves 614, 616 are fluidically connected to a spout or faucet 622; the sprayer hot and cold water control valves 615, 617 are fluidically connected to the sprayer 602. In particular, the T-joint 623 is fluidically connected between the control valves 615 and 617 and also fluidically connected to the sprayer through a flexible hose 636. The output of the control valves 615 and 617 is thus directed through the T-joint 623 through the hose 636 to the sprayer 602.

In operation, the anti-scald valve 604 serves to limit the maximum temperature of water flowing therethrough. Although the valve 604 is illustrated as positioned in the main hot water line where it will operate to provide a maximum limit to the water flowing through the system, other valve placements/configurations may be used. For example, multiple valves may be used to limit the temperature of the water output of the system, with a first valve 604 positioned in fluidic communication between control valves 614, 616 and spout 622 and a second valve 604 positioned in fluidic communication between control valves 615, 617 and sprayer 602 (not shown). The anti-scald valve 604 provides water at a predetermined maximum temperature to the fill hardware, i.e., the spout 622 and the hand-held shower 602. Preferably, the anti-scald valve also controls the water pressure spout 622 and/or to the hand-held shower 602 by reducing pressure fluctuations and providing a predetermined maximum pressure limit. More preferably, the anti-scald valve 604 both balances the temperature of the mixed water and reduces pressure fluctuations at the spout 622 and/or hand-held shower 602. Still more preferably, the anti-scald valve 604 balances both the temperature and the pressure of the mixed water flowing therefrom. The use of a compact anti-scald valve 604 in the system 600 eliminates the necessity for a diverter valve, thereby reducing the number and complexity of the required plumbing fittings as well as reducing the cost of the system 600.

The system 600′ of FIG. 10 is identical to that of FIG. 9 except that a diverter valve 639 replaces the control valves 615 and 617 and the adjoining T-joint 623. The valves 614 and 616 are each fluidically connected to the diverter 639, which is fluidically connected to the sprayer 602 through the hose 636. The diverter is preferably mounted beneath the tub deck surface. A diverter control handle 641 is preferably connected to the diverter 639 and more preferably extends through the deck surface 636. The valve 604 operates essentially identically as described above.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

1-24. (canceled)

25. A method for controlling the water temperature and pressure output from a hand held shower head, comprising the steps of:
a) connecting a pressure balancing valve having an output and a plurality of inputs to a bathtub deck;
b) hydraulically connecting the pressure balanced valve output to the hand held shower head;
c) hydraulically connecting a hot water source and a cold water source to respective pressure balanced valve inputs; and
d) controlledly actuating the pressure balanced valve to achieve a water output from the hand held shower characterized by a predetermined maximum pressure;
wherein the pressure balanced valve, the hot water source, the cold water source and the hand held shower head are hydraulically connected without the need of a diverter.

26. The method of claim 25, wherein the pressure balanced valve is adapted to supply water to the hand held shower head, wherein the water has a water pressure and a water temperature, and wherein the water pressure and water temperature are controlled by the pressure balanced valve.

27. A method for controlling the water temperature and pressure output from a hand held shower head independent of any hot and cold water valves connected to a spigot for controlling the filling of a bathtub, comprising the steps of:
a) connecting a compact pressure balanced valve having an output and a plurality of inputs to a bathtub deck;
b) fluidically connecting the compact pressure balanced valve output to the hand held shower head;
c) fluidically connecting a hot water source and a cold water source to respective pressure balanced valve inputs; and
d) flowing water characterized by a predetermined maximum pressure and maximum temperature from the pressure balanced valve to and through the hand held shower head;
wherein the pressure balanced valve, the hot water source, the cold water source and the hand held shower head may be actuated independently of any hot and cold water valves connected to the spigot for filling the bathtub.

28. A method for avoiding scalding a bather with hot water from a hand held shower head, comprising the steps of:
a) operationally connecting hot and cold water supplies to a bathtub fill spigot;
b) operationally connecting a compact pressure balanced valve having an output and a plurality of inputs to a bathtub deck;
c) operationally connecting the compact pressure balanced valve output to the hand held shower head;
d) operationally connecting a hot water source and a cold water source to respective pressure balanced valve inputs; and
e) actuating the hand held shower head to achieve a water output characterized by a predetermined pressure and maximum temperature from the pressure balanced valve;
wherein the pressure balanced valve, the hot water source, the cold water source and the hand held shower head are operationally connected without the need of a diverter; and
wherein the pressure balanced valve, the hot water source, the cold water source and the hand held shower head may be actuated independently of the bathtub fill spigot.

29. A method for avoiding scalding a bather with hot water from a hand held shower head, comprising the steps of:
a) operationally connecting a first hot water pipe and a first cold water pipe to a bathtub fill spigot;
b) operationally connecting a second hot water pipe and a second cold water pipe to a compact pressure balanced valve having an output and a plurality of inputs;
c) connecting the pressure balanced valve to a bathtub deck;
d) operationally connecting the compact pressure balanced valve output to the hand held shower head;
e) actuating the hand held shower head to achieve a water output characterized by a predetermined maximum pressure and a predetermined maximum temperature from the pressure balanced valve;
wherein the pressure balanced valve, the second hot water pipe, the second cold water pipe and the hand held shower head are operationally connected without the need of a diverter; and
wherein the hand held shower head and the bathtub fill spigot may be concurrently actuated to flow water of different respective temperatures and pressures.
